(19) United States
(12) Patent Application Publication
(10) Pub. No.: US 2002/0134299 A1
(43) Pub. Date: Sep. 26, 2002

(54) Multipurpose transparent bookmark with a "clip"

(76) Inventor: Hong Yau (alias Jerry) Chua, Boca Raton, FL (US)

Correspondence Address: Mr. Hong Yau Chua, P.O. BOX 293188, DAVIE, FL, 33329-3188, US

(21) Appl. No.: 09/766,953

(22) Filed: Jan. 22, 2001

(51) Int. Cl. B42D 9/00

(52) U.S. Cl. 116/237; 281/42

(57) ABSTRACT

A multipurpose transparent bookmark with a “clip” that clips onto a page with the help of an inset flap 14, the “clip.” This clip 14 prevents a bookmark from slipping off a page. With this transparency property, nothing on a page will be obstructed. Hence a reader can mark on this bookmark exactly where he/she has left off by using a marker, sticker note/arrow, etc. The protruding blank space 20 available on the top of the flap acts like a tab, which provides an added space for notation. Thus, it has a myriad of applications, including being used as a bookmark, place marker, reference tab, categorizing device, sequencing or numbering device for any books, documents, paperwork, etc.

### BACKGROUND OF THE INVENTION

This invention pertains to the stationery products such as bible, reference material in paper form, documents, archives, etc. It is a transparent bookmark with a “self-clinging” clip. A user is able to do any type of marking on the bookmark for references, categorizing, sequencing, numbering, etc. Since I have been reading the Bible, I have found it very difficult to track where I left off Furthermore, the Bible is usually printed into TWO columns of text on a page versus ONE column of text on regular books. With this invention of transparent bookmark, anyone is able to “clip” the bookmark on the page and mark on the bookmark where exactly one has left off using a marker, a sticky note/arrow, etc. The present way of marking on a Bible as found in bookstores, are using a strip of fabric or ribbon laying across the text. This is not very practical if precise location of the text is needed to be marked. Moreover this bookmark is invented with a protruding blank space on the top of a bookmark when a bookmark is clipped to a page. This protruding space can act like a tab. Hence this blank space can be used for identification, categorizing, sequencing, numbering, dating, etc. by marking the relevant information on the space for future ease of lookup.

A search in the United States Patent And Trademark Office's databases using search strings such as “CCL/116 and bookmark”, “CCL/281 and bookmark”, and “CCL/D19 and bookmark”, has revealed many occurrences. But the following patents seem to be of relevance to this invention:

| US. Pat. No. | INVENTOR | ISSUE DATE |
|---|---|---|
| 4,898,115 | Bowlay-Williams; Iris E. | Feb. 6, 1990 |
| 4,934,304 | Rosen; Jan. A. | June 19, 1990 |
| 5,918,906 | West; Zetta L. | July 6, 1999 |

### BRIEF SUMMARY OF THE INVENTION

The general idea of this invention is a flexible, economical, and practical transparent bookmark for referencing, categorizing, sequencing, numbering, dating, etc. Furthermore, it has a “clipping flap” to prevent a bookmark from falling off a page. Of course, the beauty of this bookmark is that it is transparent. Thus it does not obstruct any text—a see through feature. This feature allows the exact location on a page to be marked if so desired versus a traditional bookmark, which covers what is underneath the bookmark. It is light and very flexible which is unlikely to deface or destroy a page. Moreover, this transparent bookmark can be a tabbing device.

### BRIEF DESCRIPTION OF THE SEVERAL VIEWS OF THE DRAWING

FIG. 1 is a perspective view of a fundamental multipurpose transparent bookmark with an inset flap or a “clip;”

FIG. 2 is a side elevation view of FIG. 1 with the flap or “clip” bent backward;

FIG. 3 is a front view of a multipurpose transparent bookmark with two “clips” by the side;

FIG. 4 depicts a front view of a multipurpose transparent bookmark clips onto a page;

FIG. 5 depicts a back view of a multipurpose transparent bookmark clips onto a page;

FIG. 6 is a front view of a multipurpose transparent bookmark with a symbol of a cross;

### DETAILED DESCRIPTION OF THE INVENTION

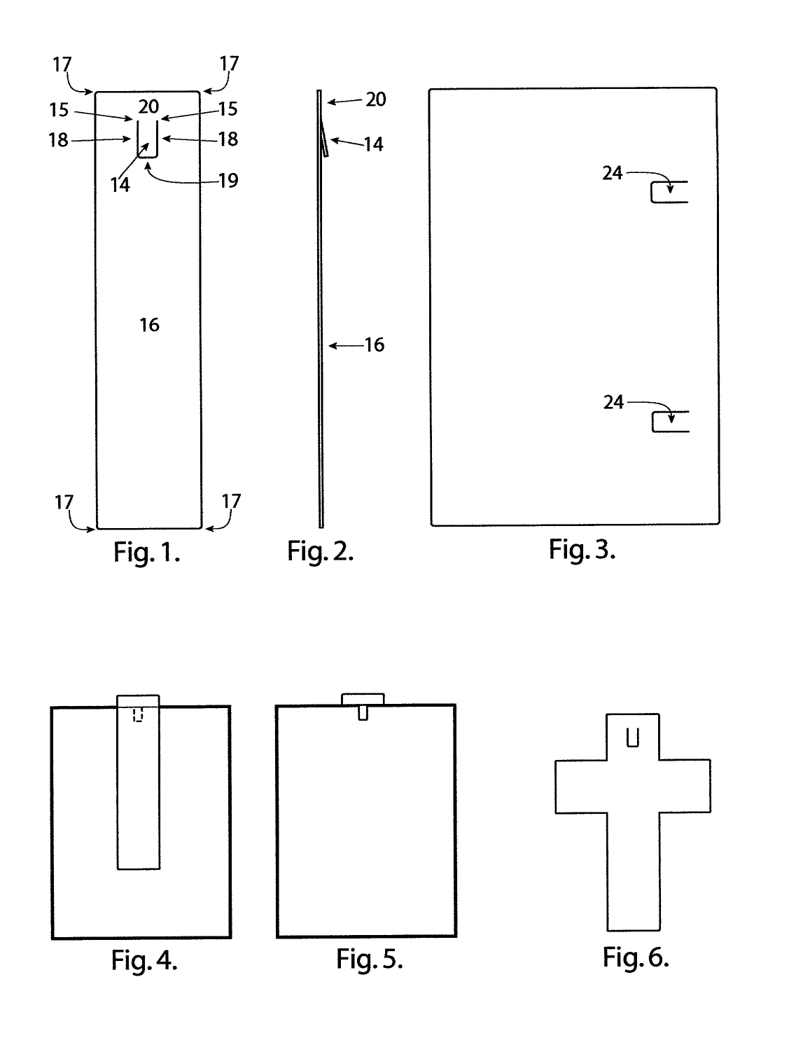

This invention is a special designed transparent bookmark with a “clip” (FIG. 1). It has an inset flap 14 near the top-center (about ½ of an inch from the top) of a bookmark. This inset flap is also called the “clip.” The dimension of that inset flap is ¾ of an inch by length and ⅜ of an inch by width, allowing a bookmark to be clipped onto a page. A bookmark from this invention can be clipped to a page simply by pushing the flap (as mentioned above) downward (FIG. 2) and sliding the body 16 of the bookmark to the front of a desired page until the top of a page touches the “pivot” 15 of the flap. Once it touches the “pivot”, let go of the pushed down flap which will automatically return to its original or closed position. With this bookmark so positioned, the body of the bookmark is on the front of a page (FIG. 4) and the flap of the bookmark is on the back of a page (FIG. 5). In other words, a page is partially sandwiched between the body 16 and the flap 14 of the bookmark. Thus this “clipping” effect prevents a bookmark from slipping off a page. Since the material used to create this bookmark is made of static-adhesive material such as polyester, the body of the bookmark has a tendency to cling to a page. This will further prevent a bookmark from slipping off a page. Furthermore, this bookmark is made of transparency material, which allows a user to scribble any notes, comments, markings, pointers, etc. on it. The transparency property permits any printed text, picture, etc. on a page NOT to be blocked from viewing. The material to create this bookmark can easily be found from any transparency used on an overhead projector. Note that the four corners 17 of this bookmark is smoothed out to curvature form lest it is too sharp and pointed.

Be aware that the flap is created by 3 incisions on the SAME bookmark itself Two incisions on the sides 18 to create the length and one incision on the bottom 19 to create the width. Thus the flap 14 is NOT GLUED onto the body of the bookmark but is from the original body of the bookmark!

This transparent bookmark is useful as a reference marking for anyone who has to refer to printed material for future use. For example, a preacher can use this bookmark to prepare his/her sermon especially frequent references to a bible. He/she can use a marker pen to mark on a transparent bookmark to denote where a reference begins and ends in a particular book and verses in a bible. Of course, erasable markers can be used so that the bookmarks are reusable. Furthermore, with the protruding blank space 20 available above the flap of a bookmark, he/she can write down the sequences of the references, date, etc. This protruding space 20 acts like a tab. This tab allows a reader to locate the references quickly and efficiently without looking the entire page (or two pages) and not defacing the page with markings and writings.

Lastly, the length of this transparent bookmark can be of any length as long as the body 16 is longer than the “clip” or the inset flap 14 i.e., the body 16 extending beyond the bottom of the “clip” 19.

What I claim as my invention is:

1. A multipurpose transparent bookmark with a “clipping” device to prevent the bookmark from slipping off a page and does not obscure any underlying text, picture, contents, etc. of a page because of the “see through” property on the bookmark.

2. The bookmark in accordance with claim 1 wherein said material of construction is transparent material such as a transparency (with thickness of a couple or a few mil) for overhead projector devices; such material could be made of polyester, polymer, or any improved material by future inventors in transparencies.

3. The bookmark in accordance with claim 2 possesses a “clinging” attribute (static adhesive) due to the natural effect of the transparent material.

4. The bookmark in accordance with claim 3 is further enhanced with an inset flap near the top-center of this bookmark so that the flap acts like a “clip” on a page (FIG. 1); such “clip” can be clipped onto a few pages of any text, depending on the thickness of each page—usually it can be clipped onto just a single page of any text unless the thickness of that page is extremely thin.

5. The bookmark in accordance with claim 4 can have an inset flap on the side (FIG. 3); it is not necessary to be on the top-center depending on the shape of the bookmark; perhaps multiple inset flaps may be needed to support a larger size bookmark.

6. The bookmark in accordance with claim 4 possesses a blank space above the flap which can act like a tab by marking on it the relevant information for referencing categorizing, sequencing, numbering, dating, etc. for future ease of lookup.

7. The bookmark in accordance with claim 4 permits a reader to mark concisely where he/she has left off using a marker, sticky note/arrow, etc. regardless of how many columns of text on a page.

8. The shape of this bookmark can be of any shape that fits on a page; not necessarily having to be rectangular in shape to suit different personalities; such other shapes could be: any flower, cartoon characters, symbols, etc. (FIG. 5)

9. Different color coating can be used for the background of a bookmark instead of just the clear coating in order to appeal to different age groups, genders, etc.

10. Different design, picture, font, etc. can be infused on a transparency to increase its appeal for different walks of life.

11. During mass production for this invention, the said bookmark can be of shorter or longer in length but the extra length are perforated at standard interval of one half inch, allowing a user to tear off at the desired perforation to suit the variable lengths of different sizes of books.
